(19) United States
(12) Patent Application Publication
(10) Pub. No.: US 2026/0259082 A1
(43) Pub. Date: Sep. 3, 2026

(54) OPTICAL SPECTROMETER AND RAMAN MICROSCOPE COMPRISING SUCH A SPECTROMETER

(71) Applicant: HORIBA FRANCE SAS, PALAISEAU (FR)

(72) Inventor: Brice VILLIER, PALAISEAU (FR)

(21) Appl. No.: 19/474,446

(22) PCT Filed: Mar. 28, 2024
(86) PCT No.: PCT/EP2024/058622

§ 371 Date: Oct. 10, 2025

(30) Foreign Application Priority Data
Apr. 14, 2023 (FR) 2303766

(51) Int. Cl. G01J 3/44; G01J 3/02; G01J 3/18; G01J 3/28; G01N 21/65

(52) U.S. Cl. CPC G01J 3/44; G01J 3/0208; G01J 3/0224; G01J 3/18; G01J 3/2803; G01N 21/65; G01J 2003/2813

(57) ABSTRACT

The invention relates to an optical spectrometer (10) comprising:
an aperture (13) configured to receive a source light beam,
a first optical system being configured to receive the source light beam and form a collimated light beam directed towards a diffraction grating,
the diffraction grating being configured to receive the collimated light beam and to form a diffracted light beam,
a second optical system being configured to form an image of the diffracted light beam on an image sensor.

According to the invention, the image sensor is a CMOS sensor comprising pixels (34) arranged in N rows which are oriented in a direction that is inclined at an angle alpha with respect to the spectral diffraction direction of the image of the diffracted light beam, where alpha is less than 10 degrees, N is at least 3, and each pixel has a height and a width defining a pixel aspect ratio that is greater than two.

### TECHNICAL FIELD OF THE INVENTION

The present invention generally relates to optical spectrometers.

More particularly, it relates to an optical spectrometer comprising an aperture configured to receive a source light beam, a first optical system, a diffraction grating, a second optical system and an image sensor, the first optical system being arranged and configured to receive the source light beam and to form a collimated light beam directed towards the diffraction grating, the diffraction grating being positioned so as to receive the collimated light beam and configured to form a diffracted light beam, and the second optical system being arranged and configured to form an image of the diffracted light beam on the image sensor.

The invention finds a particularly advantageous application in Raman microscopy.

It also relates to a Raman microscope.

### STATE OF THE ART

In spectrometry, and more precisely Raman spectrometry, spectral resolution and imaging resolution are key parameters to be optimized. Often, spectral resolution is often favoured over imaging resolution, resulting in spectra that are spread out in height (i.e. in a direction perpendicular to the direction of spectral dispersion) due to an optical aberration known as astigmatism.

The spectrum is then composed of spectral lines generally recorded by a matrix sensor of the CCD or CMOS type, composed of square pixels. The spectral lines are therefore spread over several pixels, and the different pixel values are added together to obtain the value of the spectral signal.

This technique is costly in terms of time (the time required to read several pixels is higher than for a single pixel in a CCD sensor) and noise (for example, in a CMOS sensor, each pixel acquires a read noise B, so the total noise associated with reading N pixels is B*\sqrt{N}).

Other types of sensors exist, such as CCD sensors with a single row of rectangular pixels. These sensors are made up of pixels with a large surface area (enabling the full height of the spectrum to be captured in a single pixel for all wavelengths), generating a significant measurement noise because the dark current is proportional to the surface area of the pixel. Moreover, these sensors are not suitable for high-performance Raman spectrometry. Indeed, to perform Raman spectrometry, and more specifically Raman microscopy, it may be necessary to image several spectra simultaneously over the height of the detector.

There is a need for an imaging optical spectrometer that provides both good spectral resolution and ability to image one or more spectra simultaneously, with reduced measurement noise and limited reading time.

### DISCLOSURE OF THE INVENTION

In order to remedy the above-mentioned drawbacks of the state of the art, the present disclosure relates to an optical spectrometer comprising an aperture configured to receive a source light beam, a first optical system, a planar diffraction grating, a second optical system and an image sensor, the first optical system being arranged and configured to receive the source light beam and to form a collimated light beam directed towards the diffraction grating, the diffraction grating being positioned so as to receive the collimated light beam and configured to form a diffracted light beam, and the second optical system being arranged and configured to form an image of the diffracted light beam on the image sensor.

According to the invention, the image sensor is a CMOS sensor comprising pixels arranged in N rows oriented in a direction that is inclined at most by an angle alpha with respect to the spectral diffraction direction of the image of the diffracted light beam, where the angle alpha is less than 10 degrees, N being an integer higher than or equal to 3, each pixel has a height h and a width w defining a pixel aspect ratio R=h/w, wherein the pixels all have the same height h and the same width w and the pixel aspect ratio R is higher than 2.

The present disclosure proposes to use a CMOS sensor including several rows of rectangular pixels.

Therefore, thanks to the use of a CMOS sensor, the reading time is reduced. The aspect ratio is adapted to reduce the measurement noise. Moreover, the use of at least three rows of pixels makes it possible to use the spectrometer for imaging applications (for example, Raman microscopy) or for spectro-polarimetry applications.

Preferably, the pixel aspect ratio R is less than or equal to 20.

In an exemplary embodiment, each row of the sensor comprises M pixels, M being between 512 and 4096.

Advantageously, the pixels are arranged in M columns.

According to a particular aspect, the image sensor comprises an electronic system configured to collect and sum the values of pixels of a same column.

According to an embodiment, the number N of rows is less than or equal to 256, or even 128.

According to another particular aspect, the height h of a pixel is between 6 micrometres and 300 micrometres and the width w of a pixel is between 2 micrometres and 50 micrometres.

In an exemplary embodiment, the aperture is a rectangular entry slit having a slit height Hf. In another embodiment, the aperture comprises at least one circular or square aperture.

Optionally, the optical spectrometer comprises an optical polarization splitter arranged and configured to split the diffracted light beam into two polarized beams, the optical spectrometer being configured to form simultaneously an image of each of the two polarized beams on the image sensor and wherein the image of one of the two polarized beams is separated from the image of another of the two polarized beams by at least one row of pixels.

The invention also relates to a Raman microscope including an optical spectrometer according to the present disclosure.

Advantageously, the aperture comprises at least two confocal diaphragms, the optical spectrometer being configured to form simultaneously an image of each of the at least two confocal diaphragms on the image sensor and each image of a confocal diaphragm is separated from another image of another confocal diaphragm by at least one row of pixels.

Obviously, the different features, alternatives and embodiments of the invention can be associated with each other according to various combinations, insofar as they are not incompatible or exclusive with respect to each other.

### DETAILED DESCRIPTION OF THE INVENTION

The following description in relation with the appended drawings, given by way of non-limiting examples, will allow a good understanding of what the invention consists of and of how it can be implemented.

In the appended drawings:

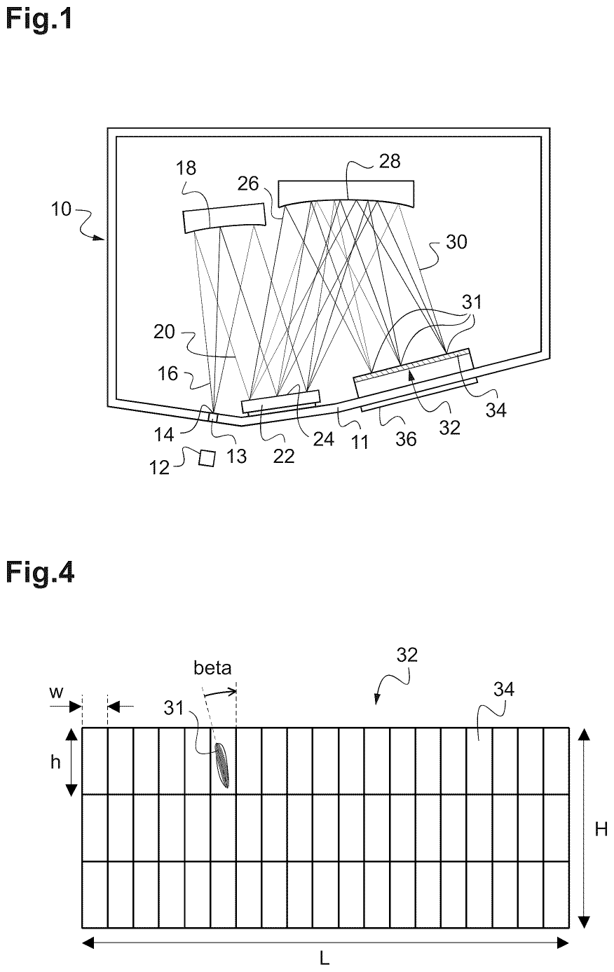

FIG. 1 is a schematic view of an optical spectrometer according to a first embodiment;

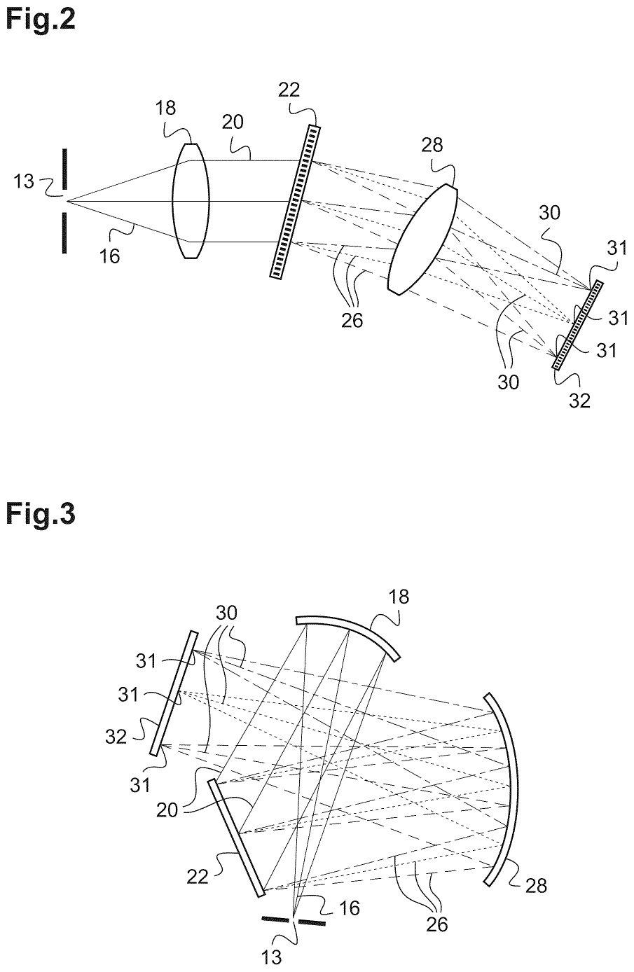

FIG. 2 is a schematic view of an optical spectrometer according to a second embodiment;

FIG. 3 is a schematic view of an optical spectrometer according to a third embodiment;

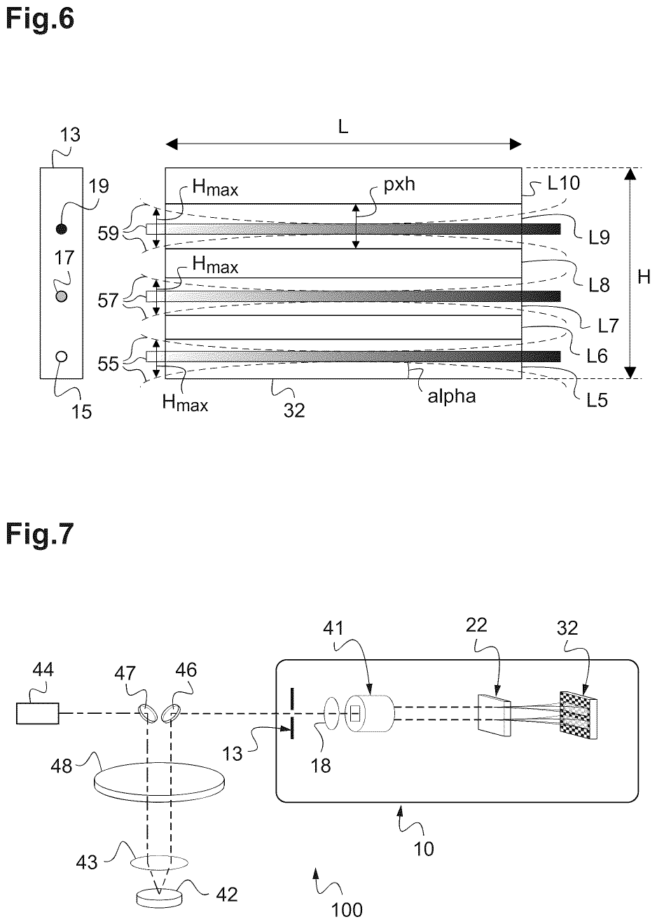

FIG. 4 is a schematic view of the detector of the spectrometer according to any one of the embodiments;

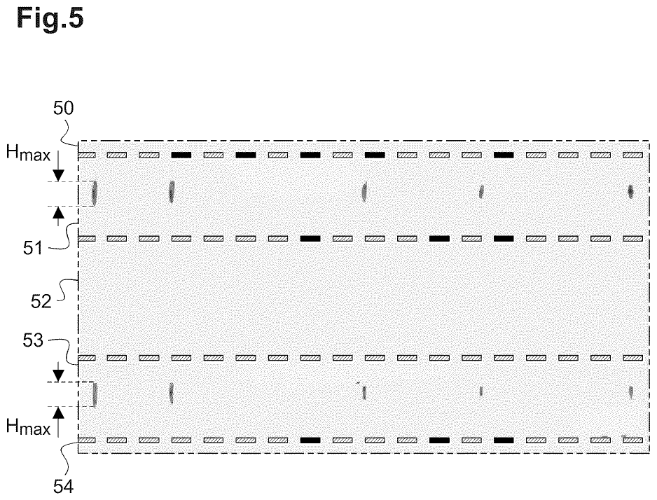

FIG. 5 is a view of an example of spectrometry image obtained on a spectrometer equipped with a CMOS sensor according to the present disclosure;

FIG. 6 is a view illustrating, on the left, an aperture comprising three confocal diaphragms and, on the right, the corresponding spectral image obtained on a spectrometer equipped with a CMOS sensor according to the present disclosure; and

FIG. 7 is a schematic view of a Raman microscope as described by the invention.

In FIG. 1, an optical spectrometer 10 according to a first embodiment is shown. The optical spectrometer 10 makes it possible to analyse a light beam coming from a light source 12, which is generally an external light.

The light source 12 can for example come from an end of a cable including several superimposed optical fibres providing light to the optical spectrometer 10.

The optical spectrometer 10 comprises a casing 11 with an aperture 13 (or porthole) configured to receive the light beam. The aperture 13 can take the form of a rectangular or circular hole, or a slit. The aperture 13 has a height Hf in the direction perpendicular to the plane of FIG. 1.

The light source 12 can be generated from any source comprising parts of the spectrum or the full spectrum. According to the application, the light source 12 here emits light in a discrete or continuous optical spectrum, extending for example from the ultra-violet to the infrared (260 nm-2 μm).

Light from the source 12 enters the casing in the form of an input beam 16 that diverges from the entry point 14 to a first optical system 18. Here, the first optical system 18 is a concave collimating mirror with a spherical curvature. The first optical system 18 redirects the light in the form of a collimated beam 20, as illustrated in FIG. 1, on a diffraction grating 22.

The diffraction grating 22 is planar and formed of straight, parallel and regularly spaced lines 24. The lines of the diffraction grating 22 are here perpendicular to the plane of FIG. 1. The diffraction grating 22 is here reflective and is positioned to receive and reflect the collimated light beam, and form a light beam 20 diffracted in different directions as a function of the different wavelengths present in the spectrum of the light source 12.

In FIG. 1, schematically, each ray incident on the diffraction grating 22 is dispersed into three rays forming the spectrally diffracted beam. Naturally, the diffraction depends on the light source 12 and is not restricted to three wavelengths. After reflection on the diffraction grating 22, the diffracted beams 26 are collimated. The diffracted beams 26 are directed to a second optical system 28.

The second optical system 28 is here a concave focusing mirror. The second optical system 28 focuses the light beams 26 into an output beam 30 that is directed towards an image sensor 32. In other words, the second optical system 28 forms an image of the diffracted beam on the image sensor 32.

In a second embodiment of the optical spectrometer 10, illustrated in FIG. 2, the diffraction grating 22 is a transmission grating. Moreover, the first optical system 18 is a refractive optical system comprising for example a collimating lens and the second optical system 28 is a refractive optical system comprising for example a lens for focusing the output beam 30 to the image sensor 32.

In a third embodiment, illustrated in FIG. 3, the optical spectrometer 10 is of the Czerny-Turner type. The diffraction grating 22 is a reflection grating. The first optical system 18 is a reflective optical system and the second optical system 28 is also a reflective optical system. This configuration makes it possible to fold the optical paths and to obtain a more compact spectrometer.

Of course, other known configurations of optical spectrometers exist, which also fall within the scope of this disclosure. In particular, the optical spectrometer can be a non-planar configuration. The optical spectrometer 10 can also include several diffraction gratings 22 arranged in series on the path of the light beam in order to increase the spectral dispersion of the light beam.

As shown in FIGS. 1 to 3, each wavelength is focused into a different image spot 31 along the image sensor 32 in the spectral diffraction direction. The spectral diffraction direction is located in a plane perpendicular to the lines of the diffraction grating 22 for an optical spectrometer 10 in planar configuration. Each image spot 31 is called spectral line. The size of the image spot 31 on the image sensor 32 for a particular wavelength of the light, i.e. perpendicular to the spectral diffraction direction, is dependent on the size of the input spot 14 and the ratios of various geometries of the optical components and their positioning in the optical system. The width of the imaged spot in the direction of the spectral diffraction (which is the same direction as the length of the image sensor 32) determines the spectral resolution of the optical spectrometer 10. The optical design of the optical spectrometer 10 is generally defined to maximize the spectral resolution.

Moreover, the light beams 16, 20 and 26, 30 being reflected or transmitted by curved and off-axis optical systems 18, 28, the effective focal length of the optical systems 18, 28 in the “tangential” or “meridional” plane of FIG. 1, 2 or 3 is shorter than the effective focal length of the optical systems in the “sagittal” plane perpendicular to the drawing plane. Therefore, when the image point is focused in the tangential plane, it is not perfectly focused on the sagittal plane by the second optical system 28. The light beams 30 then form a light line of each wavelength on the detector perpendicularly to the plane of FIG. 1, rather than a point. This is known as astigmatism. A spectrum imaged on an image sensor 32 and including astigmatism is shown in FIG. 6.

In FIG. 6, three source points 15, 17, 19 are shown, arranged on the entry slit 13 of the optical spectrometer. The source points 15, 17, 19 correspond for example to the ends of three optical fibres or also to the image of a spatially extended source. Each source point 15, respectively 17, 19 produces a spectrum 55, respectively 57, 59, on the image sensor 32 of an optical spectrometer 10. By way of example, the spectra 55, 57, 59 are here continuous spectra in the spectral domain considered. For each spectrum 55, 57, 59, the widening of the image spot due to astigmatism in a direction transverse to the spectral diffraction direction, i.e. in the direction of the pixel height, is indicated by two dotted lines.

Astigmatism depends on several parameters, including the wavelength. In other words, the height of the aberration, and hence of the image on the sensor, depends on the wavelength. It is observed for example in FIG. 6 that the astigmatism is higher at both ends of each spectrum. The maximum height of the aberration, i.e. of a spectral line, in the conditions of use of the optical spectrometer 10 (in particular, the wavelength range, or also the grating orientation) is called Hmax.

If the line of light is greater than the height of the image sensor 32, the light in excess is lost and the sensitivity of the optical spectrometer 10 is reduced. The image sensor 32 is here chosen to have a total height H greater than the threshold value, defined by the maximum height Hmax.

In FIG. 4, the image sensor 32 is schematically shown. The image sensor 32 here includes pixels 34 arranged into N rows, where N is an integer. N is greater than or equal to 3. Preferably, N is less than or equal to 128. The image sensor 32 has a height H and a width L. For example, the height H and a width L are H=6 mm and L=25 mm. Typically, the height H is between 1 mm and 10 mm, and the length L is between 6 mm and 30 mm.

The image sensor 32 is arranged in such a way that the pixel rows are oriented in a direction inclined at most by an angle alpha with respect to the spectral diffraction direction of the diffracted light beam image, where the angle alpha is less than 10 degrees and preferably less than 5 degrees. Advantageously, the rows of pixels 34 are oriented parallel to the spectral diffraction direction of the diffracted light beam image, in other words angle alpha is zero.

Preferably, each row comprises M pixels 34, M being between 512 and 4,096. Moreover, the pixels 34 are generally arranged in column so that the pixels 34 form a matrix on the image sensor 32. Preferably, all the pixels 34 of the image sensor 32 have the same width w and the same height h. For example, the height h of a pixel 34 is between 6 micrometres (μm) and 300 μm, and the width w of a pixel 34 is between 2 μm and 50 μm.

Each pixel 34 has a height h and a width w defining an aspect ratio of the pixel 34 R=h/w. The aspect ratio R of the pixel 34 is greater than 2.

The advantage of using such an image sensor 32 is that, contrary to a conventional sensor with square pixels, the aspect ratio of the pixels 34 makes it possible to receive a spectral line 31 on a single pixel 34. The reading noise associated with the spectral measurement then corresponds to the reading noise of a single pixel 34.

In other words, the large height h of pixel 34 makes it possible to reduce reading noise by ensuring that the light from a spectral line is measured in height on a pixel 34 despite significant vertical aberration.

As an alternative, a spectral line can be measured on two or three pixels of a same column, by summing the intensities detected over these two or three pixels of the same column. The reading noise associated with this sum over two or three pixels is still low compared with a conventional detector, where it is necessary to sum over at least twice as many pixels.

Since a spectral line has a more or less fine spectral width depending on the line measured and on the characteristics of the optical spectrometer 10, it is also possible for a spectral line to be measured on one or more pixels of the same line.

The image sensor 32 is here a CMOS sensor. The height of pixel 34 must not be too large to allow efficient operation of the CMOS circuit. The aspect ratio R is here less than 20. The height h of the pixel 34 and the aspect ratio R make it possible to maintain the performance of the image sensor 32 in terms of signal-to-noise ratio.

Moreover, the CMOS sensor technology allows 2D spectra to be acquired at a much higher speed than a conventional CCD camera with the same number of pixels 34. In practice, acquiring an image on a CCD detector with 2048×2048 pixels 34 takes about 4 seconds, whereas acquiring an image on a CMOS detector with the same number of pixels 34 is virtually instantaneous, of the order of 20 ms.

Particularly advantageously, the image sensor 32 comprises a measurement system including a parallel column analog-to-digital converter device, i.e. the image sensor 32 includes one analog-to-digital converter (ADC) by column. Such a device makes it possible to read simultaneously all the M pixels 34 of a same row and to save about a factor M in reading time.

Furthermore, in order to save data processing time, the measurement system can also sum the values of the pixels 34 over a determined portion of several adjacent pixels 34 of a same column.

Such an image sensor 32 with rectangular pixels 34 having an aspect ratio of between 2 and 20 thus have improved speed and/or signal-to-noise ratio performances with respect to the optical spectrometers 10 using matrix sensor with square or low-aspect-ratio pixels 34.

CMOS detectors have a sensitivity comparable to that of CCD detectors, which themselves have higher electronic noise than photomultiplier (PM) detectors, but much higher quantum efficiency. Moreover, CMOS detectors have a dynamic range much smaller than PM detectors. Finally, CMOS detectors are less expensive than CCD detectors.

Moreover, the arrangement of the pixels 34 in several rows makes it possible to correct thermal or mechanical drifts that may be one of the performance limitations of optical spectrometers 10. For example, in the case of an optical spectrometer 10 using several diffraction gratings, the orientation of the lines (which determines the direction of spectral diffraction) may be different between several gratings, or evolve over time. It is therefore advantageous to have several rows of pixels so that the spectrum can be obtained by summing pixels 34 according to a profile that is not exactly vertical. For example, a spectral line can be inclined by an angle beta with respect to the vertical defined by the columns of the image sensor 32, beta being less than 10 degrees (see FIG. 6). This aspect of the invention makes it possible to obtain an excellent spectral resolution with respect to the use of a sensor with a single row of rectangular pixels 34.

Moreover, it is advantageous to set the number p of rows of rectangular pixels 34 read and summed to obtain each spectrum, where p is an integer greater than or equal to 1. Indeed, according to the wavelengths and the configuration of the optical spectrometer 10, the height of the spectrum on the image sensor 32 may vary (see FIG. 6). It is then of course useful to take into account the entire height of the p rows of pixels L5, respectively L7, L9, of the image sensor 32 on which the spectrum 55, respectively 57, 59, is located. It is also advantageous to be able to exclude from this sum the groups of rows L6, L8, L10 of non-illuminated pixels 34, likely to add only reading noise. Although similar to that of a conventional sensor with square pixels 34, this operation has the advantage of using a smaller number p of rows than a conventional sensor and therefore offering a better signal-to-noise ratio. The reading being very fast, a first measurement potentially makes it possible to select the groups of pixel rows L5, respectively L7, L9, including the spectral signal.

The arrangement of pixels 34 in rows also has the advantage of enabling several spectra to be measured simultaneously on different rows of the image sensor 32, as illustrated in FIG. 6. This application is particularly advantageous in spectro-polarimetry to enable different polarization components of a beam to be imaged on different rows of pixels. This application also finds applications in Raman microscopy, for example, to form the spectral image of different points of the sample to be analysed on different rows of the optical spectrometer 10.

FIG. 7 schematically shows a Raman microscope 100 comprising an optical spectrometer 10, for example according to the second embodiment.

The Raman microscope 100 comprises a laser source 44 that sends a laser beam. The laser beam is reflected by a first mirror 47, then focused by a collimation lens 43 on a sample 42 to be studied. The sample 42 is excited by the laser and emits light that passes back through the collimation lens 43, creating a collimated beam.

The collimated beam is reflected by a second mirror 46 and focused on the aperture 13 of the optical spectrometer 10. The aperture 13 of the optical spectrometer 10 here comprises for example a confocal diaphragm.

The collimated beam passes through a first optical system 18. The first optical system 18 is here for example a collimation lens, and makes it possible to collimate the light beam after it has passed through the aperture 13 of the optical spectrometer 10.

The exiting beam of the first optical system 18 passes through a polarization splitter 41 configured to split the beam into two orthogonal polarization beams. The beam splitter 41 can for example be a Wollaston prism. As an alternative, the beam splitter 41 can be a semi-reflective plate or a Rochon prism.

The two polarized and spatially-split beams then pass through the diffraction grating 22. Here, the diffraction grating 22 is a transmission grating. The diffraction grating 22 makes it possible to diffract the polarized beams.

The diffracted beams are focused on the image sensor 32 thanks to the second optical system 28 (not shown in FIG. 7 for the sake of simplification). The second optical system 28 is here a spherical or slightly toric mirror. The image sensor 32 receives two polarized images from the aperture 13 of the optical spectrometer 10. The two polarized images are formed on distinct pixel rows of the image sensor 32.

In order to easily separate the two spectra, the optical spectrometer 10 is configured so that the two polarized images are separated by at least one row of pixels 34 on the image sensor 32. Preferably, the two polarized images can be separated by three rows of pixels 34 (each spectrum is framed by a row of black pixels 34, i.e. a row of pixels receiving no luminous flow, to ensure that the entire spectrum is displayed, plus another row of black pixels to ensure that the spectra are separated). A previous measurement enables to determine the positions of the rows of lighted pixels and the rows of black pixels, which essentially depend on the optical design and not on the sample considered.

Optionally, the Raman microscope 100 advantageously includes a wave plate 48 located in front of the aperture 13 of the optical spectrometer 10 (in the direction of light) in order to rotate the polarization at the entry of the optical spectrometer 10.

FIG. 5 shows an example of spectral measurement of the sample 42 with the Raman microscope 100 of FIG. 3. Two polarized spectra 51, 53 are observed, which are separated by an empty space 52 corresponding to one or more rows of pixels, for example three rows of pixels. The polarized spectra 51, 53 have the same spectral components but each spectral component has not the same intensity. Each spectral 51, 53 is framed by two black pixel spaces. The first spectrum 51 (the uppermost) is framed by two areas of black pixels 50, 52. The second spectrum 53 (the lowermost) is framed by two areas of black pixels 52, 54.

As an alternative, the aperture 13 can include at least two confocal diaphragms. In this case, at least two beams coming from the sample 42 are observed simultaneously.

The optical spectrometer 10 is then configured to image the two confocal diaphragms on the image sensor 32. The two images are separated by at least one row of pixels 34, and preferably three rows of pixels 34.

In the same way, the aperture 13 can comprise more than two confocal diaphragms, for example three, as illustrated for example in FIG. 6. The same reasoning applies to the number of confocal diaphragms present.

In the case where the optical spectrometer 10 is used to analyse P separate input light spots, the image sensor 32 preferably comprises at least 2P+1 rows of rectangular pixels 34 enabling the spectral images of the P spots to be sufficiently separate to avoid confusion and each spectral image to be framed by two black rows (a row of black pixels below and a row of black pixels above) to acquire the whole height of the spectrum without ambiguity.

The present invention is not in any way limited to the embodiments described and shown, but the person skilled in the art will know how to apply any variant in accordance with the present disclosure.

1. An optical spectrometer (10) comprising: at least one aperture (13) configured to receive a source light beam, a first optical system (18), a planar diffraction grating (22), a second optical system (28) and an image sensor (32), the first optical system (18) being arranged and configured to receive the source light beam and to form a collimated light beam directed towards the diffraction grating (22), the diffraction grating (22) being positioned so as to receive the collimated light beam and configured to form a diffracted light beam, and the second optical system (28) being arranged and configured to form an image of the diffracted light beam on the image sensor (32),
wherein:
the image sensor (32) is a CMOS sensor including pixels (34) arranged in N rows oriented in a direction that is inclined at most by an angle alpha with respect to the spectral diffraction direction of the image of the diffracted light beam, where the angle alpha is less than 10 degrees, N being an integer higher than or equal to 3, each pixel (34) has a height h and a width w defining a pixel aspect ratio R=h/w, wherein the pixels (34) all have the same height h and the same width w and the pixel aspect ratio R is higher than 2.

2. The optical spectrometer (10) according to claim 1, wherein the aspect ratio of the pixel R is less than or equal to 20.

3. The optical spectrometer (10) according to claim 1, wherein each row of the image sensor (32) comprises M pixels, M being between 512 and 4096.

4. The optical spectrometer (10) according to claim 3, wherein the pixels (34) are arranged in M columns.

5. The optical spectrometer (10) according to claim 4, wherein the image sensor (32) comprises an electronic system configured to collect and sum the values of pixels (34) of a same column.

6. The optical spectrometer (10) according to claim 1, wherein the number of rows N is less than or equal to 256.

7. The optical spectrometer (10) according to claim 1, wherein the height h of a pixel (34) is between 6 micrometres and 300 micrometres and the width w of a pixel (34) is between 2 micrometres and 50 micrometres.

8. The optical spectrometer (10) according to claim 1, wherein said at least one aperture (13) is a rectangular entry slit having a slit height (Hf) or wherein said at least one aperture (13) comprises at least one circular or square aperture.

9. The optical spectrometer (10) according to claim 1, comprising an optical polarization splitter (41) arranged and configured to split the diffracted light beam into two polarized beams, the optical spectrometer (10) being configured to form simultaneously an image of each of the two polarized beams on the image sensor (32) and wherein the image of one of the two polarized beams is separated from the image of another of the two polarized beams by at least one row of pixels.

10. A Raman microscope (100) including an optical spectrometer (10) according to claim 1.

11. The Raman microscope (100) according to claim 10, wherein said at least one aperture (13) comprises at least two confocal diaphragms (15, 17, 19), wherein the optical spectrometer (10) is configured to form simultaneously an image (55, 57, 59) of each of the at least two confocal diaphragms (15, 17, 19) on the image sensor (32) and wherein each image of a confocal diaphragm is separated from another image of another confocal diaphragm by at least one row of pixels.

12. The optical spectrometer (10) according to claim 2, wherein each row of the image sensor (32) comprises M pixels, M being between 512 and 4096.

13. The optical spectrometer (10) according to claim 2, wherein the number of rows N is less than or equal to 256.

14. The optical spectrometer (10) according to claim 3, wherein the number of rows N is less than or equal to 256.

15. The optical spectrometer (10) according to claim 4, wherein the number of rows N is less than or equal to 256.

16. The optical spectrometer (10) according to claim 2, wherein the height h of a pixel (34) is between 6 micrometres and 300 micrometres and the width w of a pixel (34) is between 2 micrometres and 50 micrometres.

17. The optical spectrometer (10) according to claim 3, wherein the height h of a pixel (34) is between 6 micrometres and 300 micrometres and the width w of a pixel (34) is between 2 micrometres and 50 micrometres.

18. The optical spectrometer (10) according to claim 4, wherein the height h of a pixel (34) is between 6 micrometres and 300 micrometres and the width w of a pixel (34) is between 2 micrometres and 50 micrometres.

19. The optical spectrometer (10) according to claim 2, wherein said at least one aperture (13) is a rectangular entry slit having a slit height (Hf) or wherein said at least one aperture (13) comprises at least one circular or square aperture.

20. The optical spectrometer (10) according to claim 3, wherein said at least one aperture (13) is a rectangular entry slit having a slit height (Hf) or wherein said at least one aperture (13) comprises at least one circular or square aperture.
